(19) United States
(12) Patent Application Publication
(10) Pub. No.: US 2022/0008767 A1
(43) Pub. Date: Jan. 13, 2022

(54) PROTECTING BUILDINGS AGAINST WILDFIRE AND STRONG WIND

(71) Applicant: Hung V. Tran, San Jose, CA (US)

(72) Inventor: Hung V. Tran, San Jose, CA (US)

(21) Appl. No.: 16/927,450

(22) Filed: Jul. 13, 2020

(51) Int. Cl. A62C 3/02; E04B 1/94; E04H 15/34; E04H 15/54

(52) U.S. Cl. CPC A62C 3/0214; E04B 1/94; A62C 3/0264; E04H 15/54; E04H 15/34

(57) ABSTRACT

Apparatuses and methods for protecting buildings which are likely to fall in the path of wildfire and/or strong wind are disclosed. The apparatus comprises two main parts: the first part comprises a set of rigid poles pre-installed in the ground surrounding a building to be protected, and, the second part comprises a set of frames, each frame supporting a mesh that, when extended over the building to be protected, shields at least a portion of the building underlying the mesh from the destructive force of fire and/or strong wind. The set of frames with its corresponding meshes, when assembled together, forms a continuous protective pyramid-shaped net that covers the entire building. The set of frames and the set of rigid poles have complementary mechanical receptacles to lock with one another so that the rigid poles collectively provide ground support when the frames are deployed over the building.

### TECHNICAL FIELD

Implementations of the disclosure relate to techniques for protecting individual buildings or a cluster of buildings against destructive fire as well as against strong winds that can spread the fire.

### BACKGROUND

Wildfires are one of the most destructive natural events that can cause widespread loss of tangible assets, and sometimes even human and/or animal lives, if not prevented or contained early enough. Certain geographical areas have natural conditions (e.g., type and distribution of vegetation, temperature, wind pattern, low humidity etc.) that increase the possibility of wildfire, especially in certain seasons. Sometimes willful or negligent human activities may start a fire, which then spreads rapidly because of the natural conditions being conducive to wildfire.

Once wildfire starts, public entities (and sometimes even private entities) need to devote significant resources to contain damages. For example, the 2018 wildfire season was the deadliest and most destructive wildfire season in recorded history of California, with more than 8500 fires burning close to 2 million acres, according to the California Department of Forestry and Fire Protection (Cal Fire) and the National Interagency Fire Center (NIFC), as of Dec. 21, 2018. Through the end of August 2018, Cal Fire alone spent $432 million on operations related to wildfire containment. As of May 2019, insurance claims related to the 2018 fire season in California had reached $12 billion, most of which associated with the Camp Fire in Butte County.

Strong wind may aggravate a wildfire. Even without a fire, strong wind itself (e.g., tornadoes, thunderstorms, hurricanes etc.) can cause significant structural damage. In 2018, insured losses from U.S. tornadoes/thunderstorms totaled $14.1 billion.

### SUMMARY

Aspects of the disclosure are directed to apparatuses and methods for protecting assets, including dwellings and other buildings, which are likely to fall in the path of a spreading wildfire and/or strong wind. Entities with proprietary, financial, humanitarian or other interest in preventing fire damage may use these methods and apparatuses. Note that the word “building” encompasses an individual building or a cluster of buildings. Examples of buildings include, but are not limited to: residential buildings, commercial buildings, marketplaces, conference centers, community centers, sports complexes, entertainment centers, hospitals, schools, city halls, libraries, storage facilities, transportation centers, public utility buildings, industrial complexes etc.

The apparatus disclosed herein comprises two main parts: the first part comprises a set of rigid poles pre-installed in the ground surrounding a building to be protected, and, the second part comprises a set of frames, each frame supporting a mesh that, when extended over the building to be protected, shields at least a portion of the building underlying the mesh from the destructive force of fire and/or strong wind. The set of frames with its corresponding meshes, when assembled together, forms a continuous protective pyramid-shaped fire-resistant net that covers the entire building. The set of frames and the set of rigid poles have complementary mechanical receptacles to lock with one another so that the rigid poles collectively provide ground support when the frames are deployed over the building to be protected.

In certain embodiments, a fireproof sheet may be extended over and supported by the frames and the corresponding meshes creating the continuous protective net. In certain other embodiments, water may be sprayed on the meshes to create a wet shield around the building to be protected.

### BRIEF DESCRIPTION OF THE DRAWINGS

The accompanying drawings, which are incorporated herein and form a part of the specification, illustrate the disclosure and, together with the description, further serve to explain the principles of the disclosure and to enable a person skilled in the pertinent art to make and use the disclosure. The disclosure is illustrated by way of examples, and not by way of limitation, in the figures of the accompanying drawings. The dimensions shown are not necessarily drawn to scale.

FIG. 1 illustrates a set of rigid poles pre-installed around a building to be protected from fire and strong wind, in accordance with embodiments of the disclosure

FIG. 2 illustrates an example frame with a corresponding mesh, in accordance with embodiments of the disclosure.

FIG. 3 illustrates a single frame with its corresponding mesh after being attached with the pre-installed rigid poles and sprayed with water, in accordance with embodiments of the disclosure.

FIG. 4 illustrates a set of two frames with corresponding meshes assembled and attached with the pre-installed rigid poles to partially enclose the building, in accordance with embodiments of the disclosure.

FIG. 5 illustrates a set of four frames with corresponding meshes assembled and attached with the pre-installed rigid poles to fully enclose the building from all sides including a fire-resistant cover on the assembled frames, in accordance with embodiments of the disclosure.

FIG. 6 illustrates water being sprinkled on a fully-assembled set of four frames with a fire-resistant cover thereon, in accordance with embodiments of the disclosure.

### DETAILED DESCRIPTION

The present disclosure applies to a fire/wind protection apparatus that comprises a set of rigid poles pre-installed in the ground surrounding a building to be protected, and, a set of frames to be mechanically attached to the rigid poles. Each frame supports a mesh that, when extended over the building to be protected, shields at least a portion of the building underlying the mesh from the destructive force of fire and/or strong wind.

Conventional fire protection systems may employ a fire-proof covering material pre-fitted to a building to be protected, wherein the fire-proof covering material is rolled out of a deployment apparatus that has to be firmly mounted on the building to be protected. See, for example, United States Patent Application Publication No. 2004/0074152, titled “Fire Protection Cover Apparatus for Structures,” by William Rogers and Christie Holliday. Conventional fire-protection apparatus may also involve other types of structural modification of the building to be protected, such as installing self-closing vents described in U.S. Pat. No. 7,191,845 by Ronald J. Loar. Another conventional fire protection apparatus does not need structural modification, but involves an elaborate network of conduits and nozzles to spray water on the building, as described in United States Patent Application Publication No. 2012/0279731, titled “Rain Maker Wildfire Protection and Containment System,” by John Wayne Howards, Sr. The present inventor recognizes that no single system exists that can offer the benefit of fire/wind protection without having to alter the building to be protected or without having to spray water directly on the building to be protected (which may lead to unwanted water damage even though fire damage is reduced).

Aspects of the present disclosure address the above and other deficiencies by designing a fire/wind protection apparatus comprising several pieces that may be assembled together swiftly. Some pieces of the apparatus may be pre-installed, while the other pieces may be attached to the pre-installed pieces to complete the full structure of the apparatus when the threat of fire/strong wind is imminent. Water may be sprayed on the apparatus itself to create a wet shield around the building, but without directly drenching the building.

In one example scenario, an insurance company might offer a customer (e.g., a homeowner, a renter, a property manager, a leaseholder) an option to choose an enhanced fire/wind protection afforded by the technique of this disclosure for a certain premium. Once the customer agrees (preferably contractually), the insurance company may pre-install the rigid poles at strategic locations around the insured building. In another example scenario, the insurance company may want to pro-actively pre-install the rigid poles at no cost to the customer, as long as the customer permits installation of the rigid poles in his/her land. In yet another example scenario, government may enter into an arrangement (contractual or otherwise) with an insurance company who offers the enhanced fire/wind protection apparatus, or may buy such a system from a supplier and pre-install the rigid poles at strategic locations within a national/state/county/city park where a building (e.g., a park ranger office or residence or a camp site) is located. In certain scenarios, a designated shelter building may be chosen to protect against fire/strong wind. For example, for large areas under fire threat, e.g., schools, civic centers, conference centers, marketplaces, amusement parks, an insurance company may select a designated shelter building to pre-install rigid poles around it. In case of emergency, people are supposed to take refuge within the designated shelter building so that even if other buildings are affected by the fire, the shelter building is protected and lives are saved.

In all these scenarios, and other scenarios within the scope of this disclosure, when the risk of wildfire/strong wind is high, the frames with the meshes may be assembled swiftly and deployed over the building to be protected by attaching the frames with the pre-installed poles around the building. Multiple sets of frames and meshes may need to be assembled together to blanket the entire building.

The mesh may comprise a metallic net, e.g., a steel net. Nets made of other fire-resistant sturdy material may also be used. The frames supporting the mesh may me made of aluminum, steel or other material that can withstand high temperature and/or strong wind, but as the same time the material is light-weight for easy portability. The frames with the meshes may be transported aerially (e.g., by helicopters, airplanes, or robust drones) or terrestrially (e.g., by cars or trucks) and dispatched at the site so that ground crew (e.g., firefighters, property owners, insurance company personnel etc.) can attach the frames with the pre-installed rigid poles. If water is available, the frames and the meshes may be drenched with water to create a wet shield around the building to be protected.

Embodiments of the present invention will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

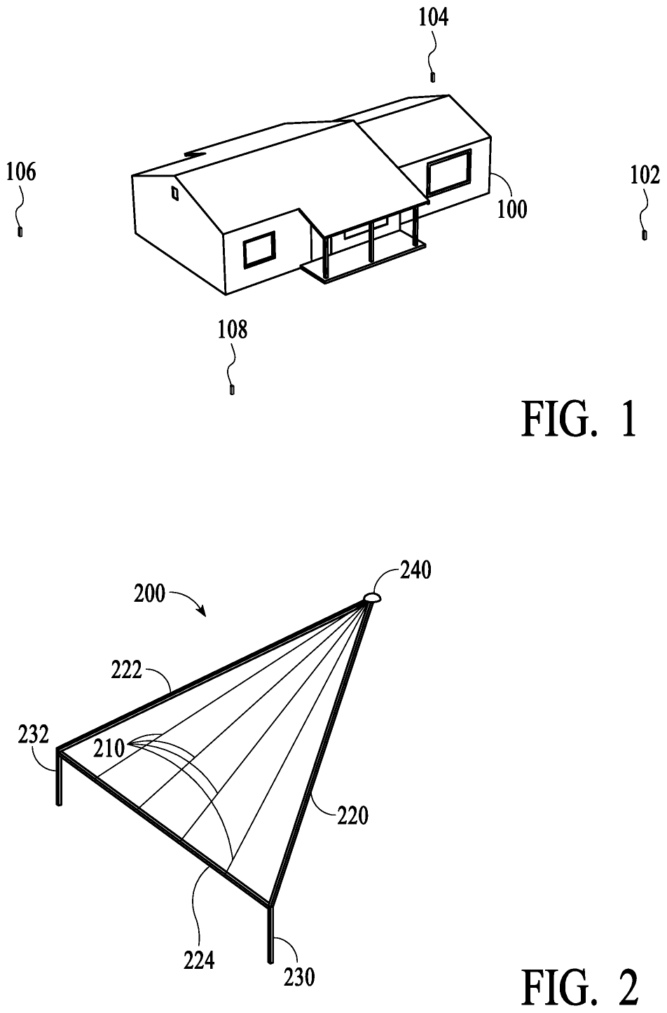

FIG. 1 illustrates a set of rigid poles pre-installed around a building to be protected from fire and strong wind, in accordance with an embodiment of the disclosure. The building 100 may be protected by insurance and the insurance company may provide the poles 102, 104, 106 and 108. Note that more than four poles may be used too. The poles 102, 104, 106 and 108 may be inserted in the ground partially to provide stable ground support. The poles 102, 104, 106 and 108 may be cemented to the ground with concrete or other means. The poles 102, 104, 106 and 108 are structurally strong enough to support the weight of the frames with the meshes (shown in FIG. 2) when they are deployed over the building 100 to be protected. A portion of each rigid pole protrudes over ground. For example, the height of the protruded part of the pole may be 1 foot above the ground. The figures are not drawn to scale.

FIG. 2 illustrates an example frame 200 with a corresponding mesh 210, in accordance with embodiments of the disclosure. A frame 200 can be triangular with a base 224 whose dimension is substantially the same as the distance between two poles (e.g., poles 106 and 108) to which the frame is to be attached with after deployment. The frame 200 has three sides 224, 220 and 222. The frame 200 supports a corresponding mesh 210, which may comprise a plurality of steel rods. Optionally, a frame 200 may have a fixture 240 to connect to a water conduit (such as a garden hose), so that the mesh 210 can be sprayed with water. The steel rods in the mesh 210 may have built-in fluid channels and drilled holes to distribute water drip substantially evenly over the mesh. The frames and the rigid poles have complementary fastening structures (for example, screws and screw holes) to be attached with each other. For example, fixtures 232 and 230 may be designed to connect to poles 106 and 108 respectively.

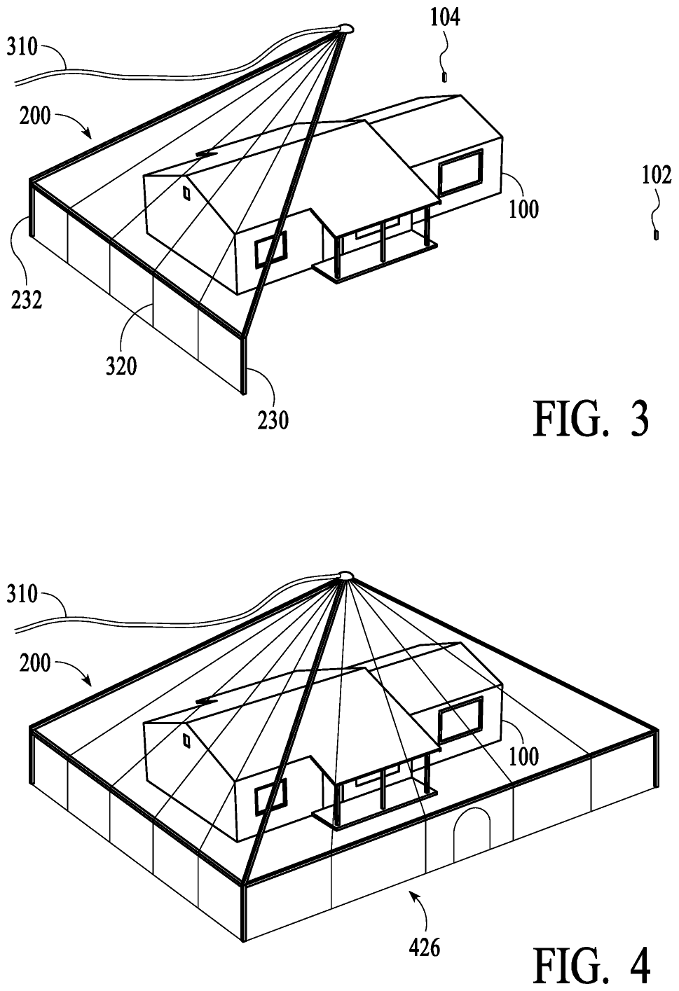

FIG. 3 illustrates a single frame 200 (referred at as ‘frame ONE’) with its corresponding mesh after being attached with the pre-installed rigid poles 106 and 108 and sprayed with water coming through hose 310, in accordance with embodiments of the disclosure. Optionally, the poles 102, 104, 106 and 108 may be taller and a fire resistant cover 320 (also referred to as fireproof sheet) may be extended between the poles.

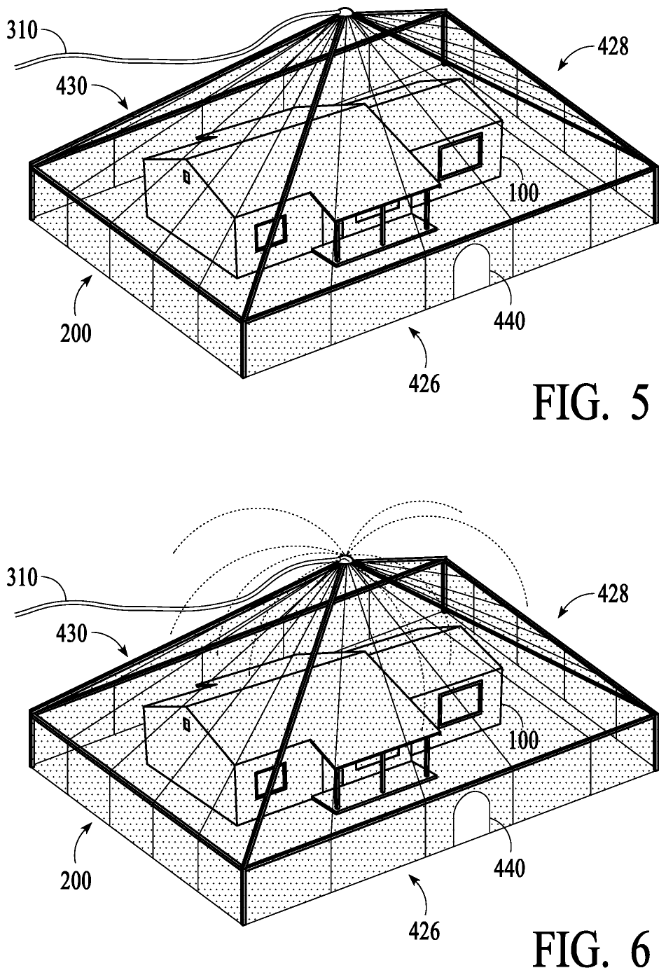

FIG. 4-5 illustrate a set of frames with corresponding meshes assembled and attached with the pre-installed rigid poles, in accordance with embodiments of the disclosure. FIG. 4 shows a partially assembled protective structure with two frames 200 and 426 installed. FIG. 5 shows a fully assembled protective structure with four frames 200, 426, 428 and 430 installed. In this embodiment, a first frame 200 (‘frame ONE’) is connected to the next frame 426 (‘frame TWO’), and so on, i.e., frame TWO 426 is connected to the next frame 428 (‘frame THREE’), frame THREE 428 is connected to the next frame 430 (‘frame FOUR’), and frame FOUR 430 is then connected back to frame ONE 200 to create a continuous net over the entire building, while each frame and its corresponding mesh covers a portion of the building 100 from one side. Note that to cover bigger areas, at least some sides of the building may require two or more segments of frames, where each individual segments may vary in shape (i.e. may not be triangular, as shown in FIG. 3). Assembling multiple frames with each other and securing the frames by attaching them to the rigid pre-installed poles should take only a few minutes. Similarly, after the fire/wind hazard is gone, the frames may be dis-assembled swiftly and taken away from the site, while the pre-installed poles may remain at the site. FIG. 5 also shows a fire resistant cover 320 (shown by the dotted pattern) is stretched over the fully assembled frames. A door 440 may be designed to allow entry/exit from the building 100 as required. FIG. 6 shows water carried by the hose 310 is sprinkled all over the assembled protective structure. Water also drips through the meshes 210 if built-in water channels are incorporated in the meshes and/or the frames.

Consumers who has a contractual relationship established with an insurance company may call the insurance company when there is a perceived threat of property damage due to fire/strong wind. Depending on the nature of the contractual relationship, the multiple frames with the corresponding meshes are carried to the insured site aerially or terrestrially as soon as possible, and then assembled on-site. Obstacles like tress, branches, chimneys etc. may be removed from near the vicinity of the poles so that nets can be attached to them, when needed, as quickly as possible. This pre-emptive approach to protect against fire/storm may be financially beneficial for the insurance company, and can avoid potential physical/emotional/financial toll on the insured persons/entities. This approach may also lead to more optimal allocation of the government's disaster relief resources.

When the danger is imminent, meshed frames (like 200 shown in FIG. 2) may be delivered via helicopter (or other aerial transport) or ground transport to the premises of the building 100. Alternatively, there are no pre-installation, and poles 102, 104, 106 and 108 with meshed frames 200 (and optionally a fire-resistant cover 320) may be delivered and quickly installed when summoned by the insured. The door 440 may be a zippered flap that can be opened or closed as required. Or the door 440 may have some other type of structure connected to the main door (or one of the other exits) of the building 100.

In another embodiment, the meshed frames may all be coupled together and folded. It is possible to expand the facets one by one. For example, a main meshed frame is first installed, supported by two poles (as shown in FIG. 3). Then the second meshed frame is unfolded and the net is further expanded and fastened between the second pole and the third pole. Then the third meshed frame is unfolded and the net is further expanded and fastened between the third pole and the fourth pole. And finally, the fourth and last meshed frame is unfolded and all four facets of the pyramid are completed with the fourth facet fastened between the fourth pole and the first pole (as shown in FIGS. 4-5).

It may be beneficial for the provider/installer of the meshed frames whether a water supply is nearby to be able to connect a garden hose 310 to the protective structure and whether the water pressure is enough to create an effective water flow on the mesh 210. It may also be beneficial to perform periodic fire drills to check the efficacy of the arrangement, e.g., how quickly the whole protective structure can be installed around the building 100, how quickly people can be evacuated etc. The periodicity can be defined contractually, e.g. every three months, every four months, etc. Or the periodicity of fire drills may be changed (more frequent in the typical fire season and less frequent in the off season).

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

The above description is intended to be illustrative and not restrictive. For example, the above-described examples (or one or more aspects thereof) may be used in combination with each other. Other implementations can be used, such as by one of ordinary skill in the art upon reviewing the above description. The abstract is provided to comply with 37 CFR 1.72(b) to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description, with each claim standing on its own as a separate implementation, and it is contemplated that such implementations can be combined with each other in various combinations or permutations. The scope of the implementations of the disclosure should be determined with reference to the appended claims, along with the full scope of equivalents to which such claims are entitled.

In the drawings, which are not necessarily drawn to scale, like numerals may describe similar components in different views. Like numerals having different letter suffixes may represent different instances of similar components. The drawings illustrate generally, by way of example, but not by way of limitation, various implementations discussed in the present document.

What is claimed is:

1. An apparatus for preventing an external fire from engulfing a building, the apparatus comprising:
a plurality of rigid poles pre-installed surrounding the building for ground support, the spacing between two adjacent rigid poles being fixed; and
a plurality of triangular shaped rigid frames, each rigid frame supporting a respective metallic mesh, such that when the plurality of rigid frames are coupled with each other and also coupled with the plurality of rigid poles pre-installed surrounding the buildings, a fire-resistant pyramid-shaped continuous metallic net is created encasing the building from the top and from all sides,
wherein each rigid frame comprises:
a base whose length matches the fixed spacing between two adjacent rigid poles;
a first side and a second side coupled to each other and to the base, such that the base, the first side and the second side form the triangular shape of the rigid frame; and
a plurality of metallic rods creating the metallic mesh that covers a triangular area bound by the base, the first side and the second side.

2. The apparatus of claim 1, wherein the apparatus further comprises:
a fire-resistant cover stretched at least partially over the fire-resistant pyramid-shaped continuous metallic net.

3. The apparatus of claim 2, wherein the apparatus further comprises:
a doorway connected to a main door of the building to allow entry into and exit from the building even when the fire-resistant pyramid-shaped continuous metallic net encases the building from the top and from all sides.

4. The apparatus of claim 1, wherein the plurality of metallic rods comprises stainless steel.

5. The apparatus of claim 1, wherein the plurality of metallic rods have fluid channels within them and surface holes to allow dripping of fluid across the metallic mesh.

6. The apparatus of claim 5, wherein at least one of the rigid frames has a receptacle on top to accept a water conduit that supplies water to flow within the fluid channels and drip across the metallic mesh through the surface holes.

7. The apparatus of claim 1, wherein a number of triangular shaped rigid frames is four such that fire-resistant pyramid-shaped continuous metallic net has four facets connected at the top.

8. The apparatus of claim 7, wherein the fire-resistant pyramid-shaped continuous metallic net is assembled by:
installing a first rigid frame by coupling a base of the first rigid frame with a first and a second rigid poles adjacent to each other;
installing a second rigid frame by coupling a base of the second rigid frame with the second and a third rigid poles adjacent to each other;
installing a third rigid frame by coupling a base of the third rigid frame with the third and a fourth rigid poles adjacent to each other; and
installing a fourth rigid frame by coupling a base of the fourth rigid frame with the fourth and the first rigid poles adjacent to each other.

9. The apparatus of claim 8, wherein one side of one rigid frame is coupled to one side of the next rigid frame.

10. The apparatus of claim 8, wherein the rigid frames are folded together and are progressively expanded by coupling the respective bases with corresponding two rigid poles, thereby creating the fire-resistant pyramid-shaped continuous metallic net.

11. A method for preventing an external fire from engulfing a building, the method comprising:
pre-installing a plurality of rigid poles surrounding the building for ground support, the spacing between two adjacent rigid poles being fixed; and
coupling a plurality of triangular shaped rigid frames with each other and also with the plurality of rigid poles pre-installed surrounding the buildings, each rigid frame supporting a respective metallic mesh, such that a fire-resistant pyramid-shaped continuous metallic net is created encasing the building from the top and from all sides,
wherein each rigid frame comprises:
a base whose length matches the fixed spacing between two adjacent rigid poles;
a first side and a second side coupled to each other and to the base, such that the base, the first side and the second side form the triangular shape of the rigid frame; and
a plurality of metallic rods creating the metallic mesh that covers a triangular area bound by the base, the first side and the second side.

12. The method of claim 11, wherein the method comprises:
delivering the plurality of triangular shaped rigid frames to be assembled on premises of the building according to an insurance contract to protect the building from ensuing fire or strong wind.

13. The method of claim 11, wherein the plurality of metallic rods have fluid channels within them and surface holes to allow dripping of fluid across the metallic mesh.

14. The method of claim 13, further comprising:
coupling a water conduit at a top of the pyramid-shaped continuous metallic net such that when water is supplied to the water conduit, water flows through metallic rods and drips through the surface holes.

15. The method of claim 11, further comprising:
extending a fire-resistant cover over the building, the cover being supported by the rigid frames and the corresponding metallic meshes.

16. The method of claim 11, further comprising:
allowing entry and exit into the building through a doorway connected to a main door of the building, even when the fire-resistant pyramid-shaped continuous metallic net encases the building from the top and from all sides.

17. The method of of claim 11, wherein a number of triangular shaped rigid frames is four, such that fire-resistant pyramid-shaped continuous metallic net has four facets connected at the top.

18. The method of claim 17, wherein the fire-resistant pyramid-shaped continuous metallic net is assembled by:
installing a first rigid frame by coupling a base of the first rigid frame with a first and a second rigid poles adjacent to each other;
installing a second rigid frame by coupling a base of the second rigid frame with the second and a third rigid poles adjacent to each other;
installing a third rigid frame by coupling a base of the third rigid frame with the third and a fourth rigid poles adjacent to each other; and
installing a fourth rigid frame by coupling a base of the fourth rigid frame with the fourth and the first rigid poles adjacent to each other.

19. The method of claim 18, wherein one side of one rigid frame is coupled to one side of the next rigid frame.

20. The method of claim 18, wherein the rigid frames are folded together and are progressively expanded by coupling the respective bases with corresponding two rigid poles, thereby creating the fire-resistant pyramid-shaped continuous metallic net.
